(19) United States
(12) Patent Application Publication
(10) Pub. No.: US 2004/0089034 A1
(43) Pub. Date: May 13, 2004

(54) ANTI-THEFT LOCK FOR A GEAR LEVER OF AN AUTOMOBILE

(76) Inventor: Chia-Yu Yu, Taichung (TW)

Correspondence Address: Chia-Yu Yu, 5F-2 No. 130 Tai Yuan North Road, P O Box 63-99, TAICHUNG, TW

(21) Appl. No.: 10/298,109

(22) Filed: Nov. 13, 2002

(51) Int. Cl. B60R 25/06

(52) U.S. Cl. 70/199; 70/247

(57) ABSTRACT

An anti-theft lock for a gear lever of an automobile includes a socket, a locking member and a ratchet member. The ratchet member includes a support seat, a cover, a spring, and a nut. In such a manner, the relative angle between the socket and the locking member may be arbitrarily adjusted rapidly, easily and conveniently, so as to fit the relative angle between the emergency brake and the gear lever of the automobile, thereby enhancing the versatility of the anti-theft lock. In addition, the nut is retained in the retaining hole of the cover, so that the nut cannot be rotated relative to the cover. Thus, the cover cannot be detached from the support seat, thereby preventing the anti-theft lock from being broken intentionally.

### BACKGROUND OF THE INVENTION

1. Field of the Invention

The present invention relates to an anti-theft lock for a gear lever of an automobile, and more particularly to an anti-theft lock for a gear lever of an automobile, wherein the relative angle between the socket and the locking member may be arbitrarily adjusted rapidly, easily and conveniently, so as to fit the relative angle between the emergency brake and the gear lever of the automobile, thereby enhancing the versatility of the anti-theft lock.

2. Description of the Related Art

A conventional anti-theft lock for a gear lever of an automobile in accordance with the prior art shown in FIGS. 1-3 comprises a socket 10, a locking member 20, and a ratchet member 11. The socket 10 is mounted on the emergency brake 1 of the automobile, and has a closed end formed having a periphery formed with a through hole 14 for passage of a bolt 15. The ratchet member 11 is mounted on the socket 10 and includes a support seat 12 mounted on the closed end of the socket 10 facing the through hole 14 of the socket 10, and a cover 52 fixed on the support seat 12. In assembly, the bolt 15 is passed through the through hole 14 of the socket 10 by a tool (not shown), then extended through the support seat 12, and is then screwed into the cover 13, so that the support seat 12 is combined with the cover 13. The locking member 20 is mounted on the gear lever 2 of the automobile, and has a first end formed with a U-shaped slot 23 to receive the gear lever 2 of the automobile and a second end provided with a lock body 22. The locking member 20 is formed with a through hole 24 for passage of a retractable locking rod 21 which has a distal end inserted into the hole (not shown) of the cover 13.

Thus, the locking rod 21 co-operates with the lock body 22, so that when the lock body 22 is disposed at a locked state, the locking rod 21 may be extended outward relative to the locking member 20, and cannot be retracted into the locking member 20, and only when the lock body 22 is disposed at an unlocked state, the locking rod 21 can be retracted into the locking member 20. In practice, the socket 10 is mounted on the emergency brake 1 of the automobile, and the locking member 20 is expanded to rest on the gear lever 2 of the automobile, so that the emergency brake 1 and the gear lever 2 of the automobile are locked by the socket 10 and the locking member 20 without movement, thereby achieving the locking effect.

However, the relative angle between the socket 10 and the locking member 20 is fixed and cannot be arbitrarily adjusted easily and conveniently. Thus, the user has to unscrew the bolt 15 to release the cover 13 from the support seat 12, to adjust the relative angle between the socket 10 and the locking member 20, so as to fit the relative angle between the emergency brake 1 and the gear lever 2 of the automobile, thereby causing inconvenience to the user, and thereby decreasing the versatility of the anti-theft lock.

### SUMMARY OF THE INVENTION

The present invention has arisen to mitigate and/or obviate the disadvantage of the conventional anti-theft lock for a gear lever of an automobile.

The primary objective of the present invention is to provide an anti-theft lock for a gear lever of an automobile, wherein the relative angle between the socket and the locking member may be arbitrarily adjusted rapidly, easily and conveniently, so as to fit the relative angle between the emergency brake and the gear lever of the automobile, thereby enhancing the versatility of the anti-theft lock.

Another objective of the present invention is to provide an anti-theft lock for a gear lever of an automobile, wherein the nut is retained in the retaining hole of the cover, so that the nut cannot be rotated relative to the cover. Thus, the cover cannot be detached from the support seat, thereby preventing the anti-theft lock from being broken intentionally.

A further objective of the present invention is to provide an anti-theft lock for a gear lever of an automobile, wherein the base member, the tube and the bent rod are manufactured individually, and are coated by a rubber layer, so that the base member, the tube and the bent rod are integrally combined with each other to form the locking member. Thus, the manufacturer needs not to integrally form the locking member by a forging process, thereby saving cost of fabrication.

A further objective of the present invention is to provide an anti-theft lock for a gear lever of an automobile, wherein after the socket is mounted on the emergency brake of the automobile, the through hole of the socket is closed by the emergency brake of the automobile, thereby preventing the anti-theft lock from being unlocked via the through hole of the socket.

In accordance with the present invention, there is provided an anti-theft lock for a gear lever of an automobile, comprising a socket, and a ratchet member, wherein:

the socket has a closed end formed having a periphery formed with a through hole for passage of a combination bolt which has a distal end formed with an outer threaded portion; and

the ratchet member is mounted on the socket and includes a support seat, a cover, a spring, and a nut, wherein:

the support seat is mounted on the closed end of the socket facing the through hole of the socket;

the cover is rotatably mounted on the support seat, and has an inner wall formed with a retaining hole;

the nut is retained in the retaining hole of the cover, and is screwed on the outer threaded portion of the combination bolt; and

the spring is mounted on the combination bolt, and is urged between a wall of the retaining hole of the cover and the nut.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a conventional anti-theft lock for a gear lever of an automobile in accordance with the prior art;

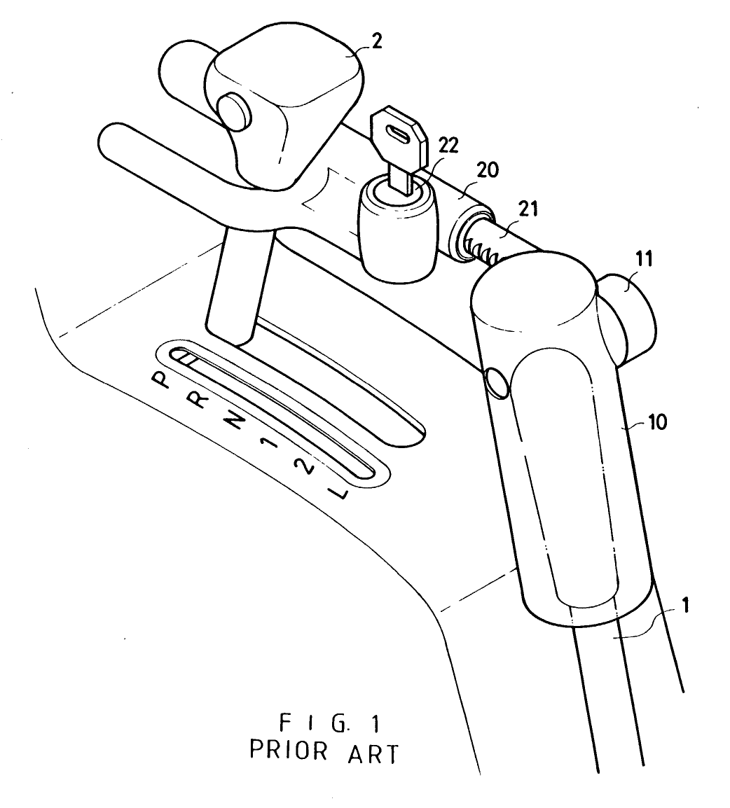

FIG. 2 is an exploded perspective view of the conventional anti-theft lock for a gear lever of an automobile in accordance with the prior art;

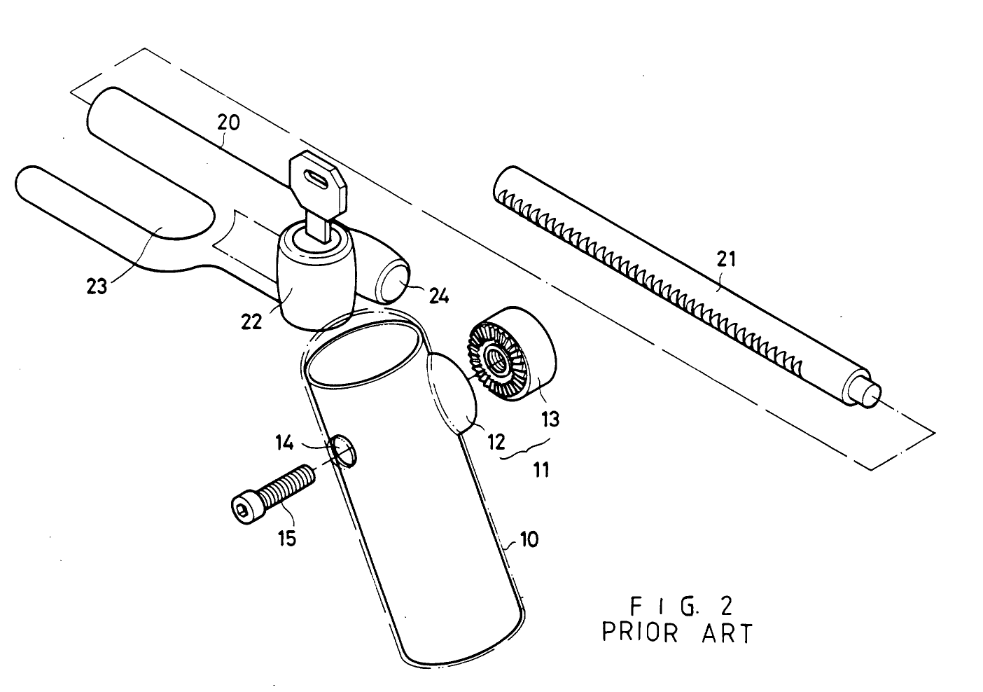

FIG. 3 is a side plan cross-sectional assembly view of the conventional anti-theft lock for a gear lever of an automobile as shown in FIG. 2;

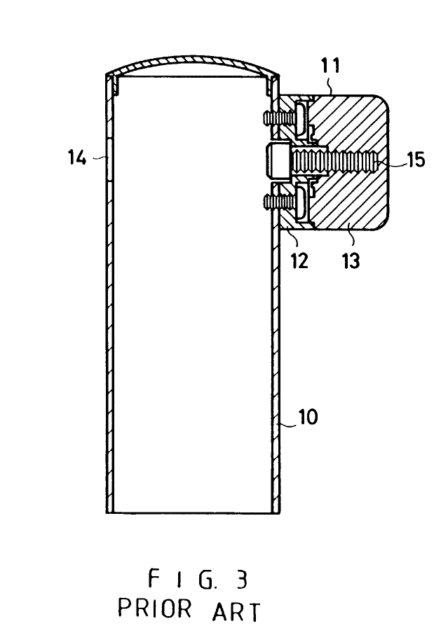

FIG. 4 is a perspective view of an anti-theft lock for a gear lever of an automobile in accordance with a preferred embodiment of the present invention;

FIG. 5 is an exploded perspective assembly view of the anti-theft lock for a gear lever of an automobile in accordance with the preferred embodiment of the present invention;

FIG. 6 is a side plan cross-sectional view of the anti-theft lock for a gear lever of an automobile as shown in FIG. 4;

FIG. 7 is a schematic operational view of the anti-theft lock for a gear lever of an automobile as shown in FIG. 6 in use;

FIG. 8 is a schematic plan operational view of the anti-theft lock for a gear lever of an automobile as shown in FIG. 4 in adjustment.

### DETAILED DESCRIPTION OF THE INVENTION

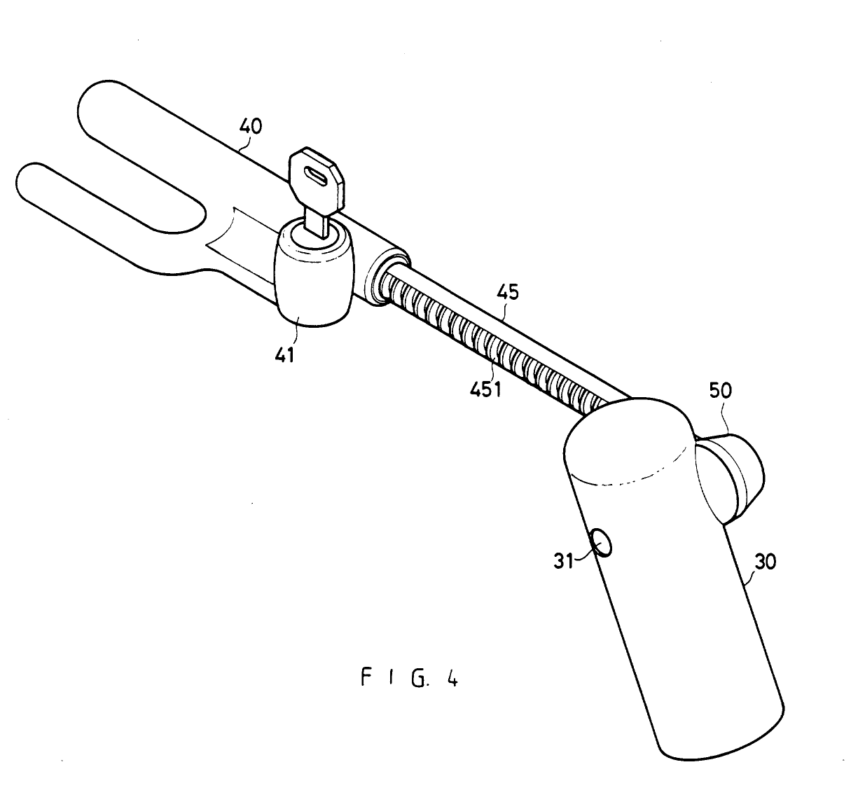

Referring to the drawings and initially to FIGS. 4-6, an anti-theft lock for a gear lever of an automobile in accordance with a preferred embodiment of the present invention comprises a socket 30, a locking member 40, and a ratchet member 50.

The socket 30 is mounted on the emergency brake (not shown) of the automobile, and has a diameter slighter than that of the emergency brake. The socket 30 has a closed end formed having a periphery formed with a through hole 31 for passage of a combination bolt 32 which has a distal end formed with an outer threaded portion 321.

The ratchet member 50 is mounted on the socket 30 and includes a disk-shaped support seat 51, a disk-shaped cover 52, a spring 55, a nut 56, and a sealing washer 57.

The support seat 51 is mounted on the closed end of the socket 30 facing the through hole 31 of the socket 30, and has a periphery formed with a plurality of one-way ratchet teeth 511.

The cover 52 is rotatably mounted on the support seat 51, and has a periphery formed with a plurality of one-way ratchet teeth 521 meshing with the one-way ratchet teeth 511 of the support seat 51. The cover 52 has an inner wall formed with a hexagonal retaining hole 54 which has a stepped shoulder 540. The cover 52 has one side formed with an insertion hole 53.

The nut 56 is retained in the retaining hole 54 of the cover 52, and is screwed on the outer threaded portion 321 of the combination bolt 32. The nut 56 has a configuration mating with that of the retaining hole 54 of the cover 52, so that the nut 56 cannot be rotated relative to the cover 52.

The spring 55 is mounted on the combination bolt 32, and is located in the retaining hole 54 of the cover 52. The spring 55 has a first end urged on the stepped shoulder 540 of the retaining hole 54 of the cover 52 and a second end urged on the nut 56.

The sealing washer 57 is secured in a distal end of the retaining hole 54 of the cover 52, so as to close and seal of the retaining hole 54 of the cover 52. The sealing washer 57 is processed by a heat treatment to have a greater hardness.

In assembly, the combination bolt 32 is passed through the through hole 31 of the socket 30 by a tool (not shown), and is then extended through the support seat 51, the retaining hole 54 of the cover 52, the spring 55 and the nut 56. Then, the outer threaded portion 321 of the combination bolt 32 is screwed on the nut 56, so that the combination bolt 32 is combined with the nut 56, and the support seat 51 is combined with the cover 52. In such a manner, the cover 52 is urged by the spring 55 to press the support seat 51, so that the one-way ratchet teeth 521 of the cover 52 mesh with the one-way ratchet teeth 511 of the support seat 51 closely. In addition, the cover 52 has a motion clearance due to the spring 55, so that the cover 52 and the support seat 51 may be rotated relative to each other, and may be automatically returned to their close connection state after rotation.

The locking member 40 is mounted on the gear lever (not shown) of the automobile, and includes a base member 42 formed with a through hole 421, a lock body 41 mounted on the base member 42, a tube 43 mounted on the base member 42, a bent rod 44 mounted on the base member 42, and a locking rod 45 inserted into the tube 43 and extended outward from the through hole 421 of the base member 42. The locking rod 45 has a distal end inserted into the insertion hole 53 of the cover 52.

It is appreciated that, the base member 42, the tube 43 and the bent rod 44 are manufactured individually, and are coated by a rubber layer, so that the base member 42, the tube 43 and the bent rod 44 are integrally combined with each other to form the locking member 40. Thus, one end of the locking member 40 has a U-shaped slot as shown in FIG. 4 so as to receive the gear lever of the automobile.

The locking rod 45 has a periphery formed with a plurality of teeth 451 by a turning process, and has a flattened side. Thus, the locking rod 45 co-operates with the lock body 41, so that when the lock body 41 is disposed at a locked state, the locking rod 45 may be extended outward relative to the tube 43 of the locking member 40, and cannot be retracted into the tube 43 of the locking member 40, and only when the lock body 41 is disposed at an unlocked state, the locking rod 45 can be retracted into the tube 43 of the locking member 40.

In practice, the socket 30 is mounted on the emergency brake of the automobile, and the locking member 40 is expanded to rest on the gear lever of the automobile, so that the emergency brake and the gear lever of the automobile are locked by the socket 30 and the locking member 40 without movement, thereby achieving the locking effect.

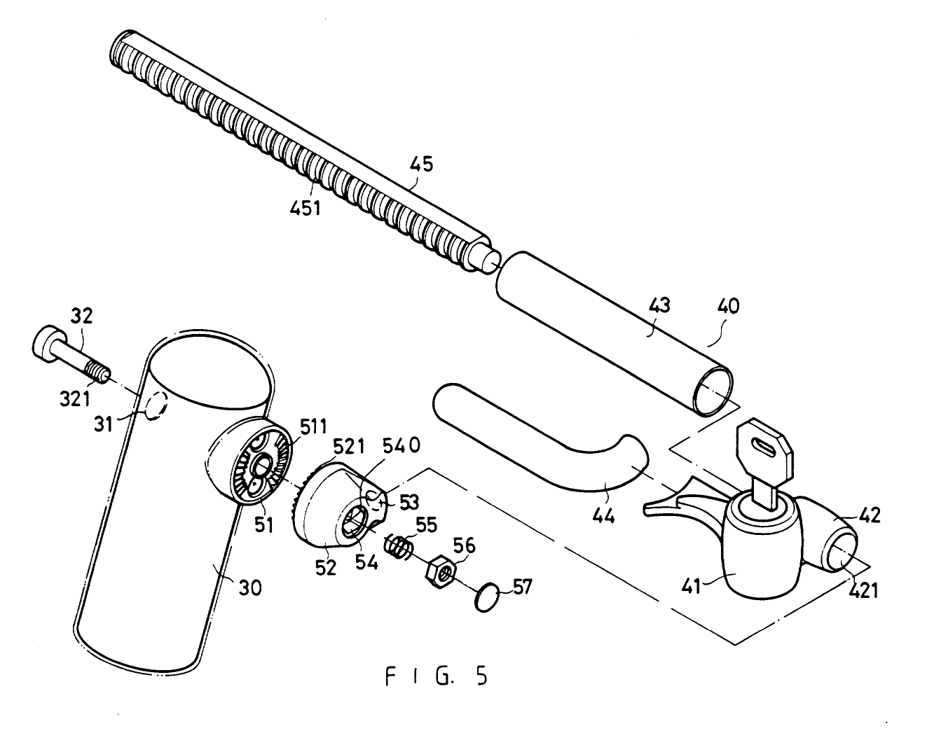

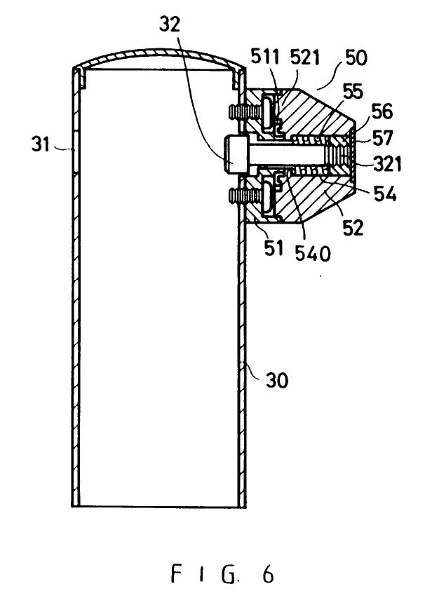

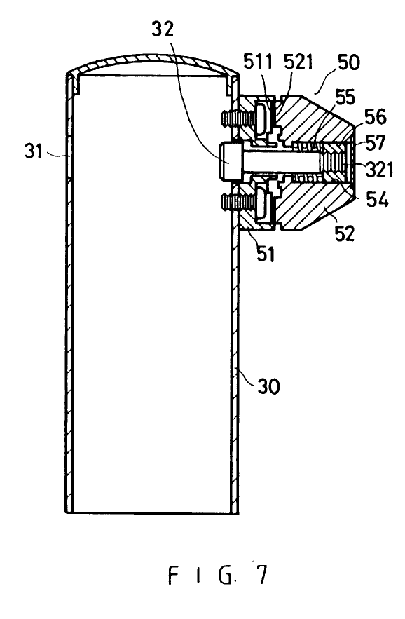

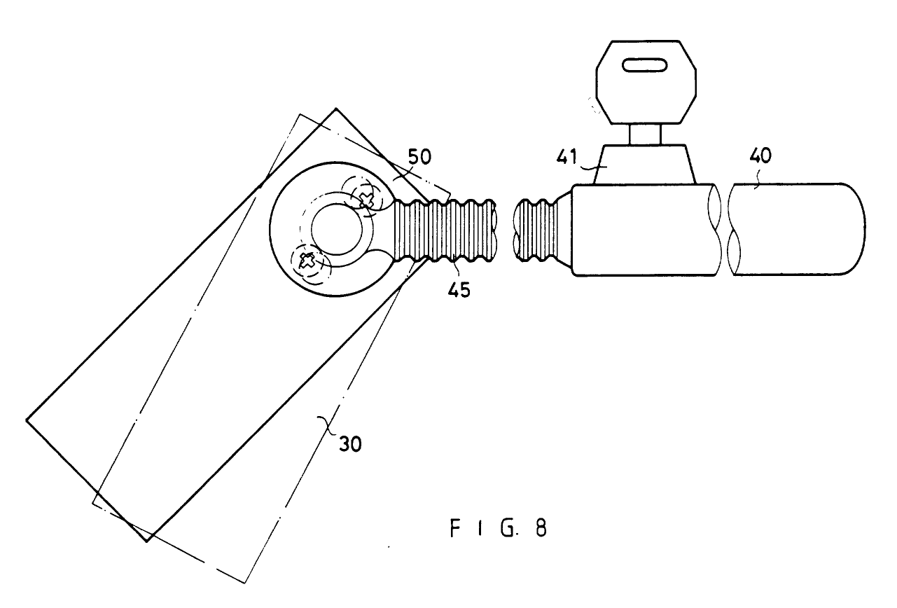

In operation, referring to FIGS. 6-8 with reference to FIGS. 4 and 5, the cover 52 is urged by the spring 55 to press the support seat 51, so that the one-way ratchet teeth 521 of the cover 52 mesh with the one-way ratchet teeth 511 of the support seat 51 closely and rigidly as shown in FIG. 6. In addition, the cover 52 has a motion clearance due to the elastically compressible feature of the spring 55, so that the cover 52 and the support seat 51 may be rotated relative to each other as shown in FIG. 7, and may be automatically returned to their close connection state after rotation.

In such as manner, the user's two hands hold the socket 30 and the locking member 40 to exert a force on the socket 30 or the locking member 40, so that the cover 52 and the support seat 51 may be rotated relative to each other and may be automatically returned to their close connection state after rotation. Thus, the relative angle between the socket 30 and the locking member 40 may be arbitrarily adjusted rapidly, easily and conveniently, so as to fit the relative angle between the emergency brake and the gear lever of the automobile, thereby enhancing the versatility of the anti-theft lock in accordance with the present invention.

It is appreciated that, the combination bolt 32 is passed through the through hole 31 of the socket 30 by a tool, and is then extended through the support seat 51, the retaining hole 54 of the cover 52, the spring 55 and the nut 56. Then, the outer threaded portion 321 of the combination bolt 32 is screwed on the nut 56, so that the combination bolt 32 is combined with the nut 56, and the support seat 51 is combined with the cover 52. Thus, after the socket 30 is mounted on the emergency brake of the automobile, the through hole 31 of the socket 30 is closed by the emergency brake of the automobile, thereby preventing the anti-theft lock from being unlocked via the through hole 31 of the socket 30.

In addition, when the cover 52 is broken, the nut 56 is retained in the retaining hole 54 of the cover 52, so that the nut 56 cannot be rotated relative to the cover 52. Thus, the cover 52 cannot be detached from the support seat 51, thereby preventing the anti-theft lock from being broken intentionally.

Further, the base member 42, the tube 43 and the bent rod 44 are manufactured individually, and are coated by a rubber layer, so that the base member 42, the tube 43 and the bent rod 44 are integrally combined with each other to form the locking member 40. Thus, the manufacturer needs not to integrally form the locking member 40 by a forging process, thereby saving cost of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. An anti-theft lock for a gear lever of an automobile, comprising a socket, and a ratchet member, wherein:
the socket has a closed end formed having a periphery formed with a through hole for passage of a combination bolt which has a distal end formed with an outer threaded portion; and
the ratchet member is mounted on the socket and includes a support seat, a cover, a spring, and a nut, wherein:
the support seat is mounted on the closed end of the socket facing the through hole of the socket;
the cover is rotatably mounted on the support seat, and has an inner wall formed with a retaining hole;
the nut is retained in the retaining hole of the cover, and is screwed on the outer threaded portion of the combination bolt; and
the spring is mounted on the combination bolt, and is urged between a wall of the retaining hole of the cover and the nut.

2. The anti-theft lock for a gear lever of an automobile in accordance with claim 1, wherein the support seat has a periphery formed with a plurality of one-way ratchet teeth, and the cover has a periphery formed with a plurality of one-way ratchet teeth meshing with the one-way ratchet teeth of the support seat.

3. The anti-theft lock for a gear lever of an automobile in accordance with claim 1, wherein the retaining hole of the cover has a hexagonal shape.

4. The anti-theft lock for a gear lever of an automobile in accordance with claim 1, wherein the retaining hole of the cover has a stepped shoulder, and the spring has a first end urged on the stepped shoulder of the retaining hole of the cover and a second end urged on the nut.

5. The anti-theft lock for a gear lever of an automobile in accordance with claim 1, wherein the nut has a configuration mating with that of the retaining hole of the cover, so that the nut cannot be rotated relative to the cover.

6. The anti-theft lock for a gear lever of an automobile in accordance with claim 1, wherein the cover has one side formed with an insertion hole.

7. The anti-theft lock for a gear lever of an automobile in accordance with claim 6, further comprising a locking member including a base member formed with a through hole, a lock body mounted on the base member, a tube mounted on the base member, a bent rod mounted on the base member, and a locking rod inserted into the tube and having a distal end inserted into the insertion hole of the cover.

8. The anti-theft lock for a gear lever of an automobile in accordance with claim 7, wherein the locking rod is and extended outward from the through hole of the base member.

9. The anti-theft lock for a gear lever of an automobile in accordance with claim 7, wherein the locking rod has a periphery formed with a plurality of teeth by a turning process.

10. The anti-theft lock for a gear lever of an automobile in accordance with claim 7, wherein the locking rod has a flattened side.

11. The anti-theft lock for a gear lever of an automobile in accordance with claim 7, wherein the base member, the tube and the bent rod are manufactured individually, and are coated by a rubber layer, so that the base member, the tube and the bent rod are integrally combined with each other to form the locking member.

12. The anti-theft lock for a gear lever of an automobile in accordance with claim 1, wherein the ratchet member further includes a sealing washer secured in a distal end of the retaining hole of the cover, so as to close and seal of the retaining hole of the cover.

13. The anti-theft lock for a gear lever of an automobile in accordance with claim 12, wherein the sealing washer is processed by a heat treatment to have a relatively greater hardness.

14. The anti-theft lock for a gear lever of an automobile in accordance with claim 1, wherein the combination bolt is passed through the through hole of the socket, and is extended through the support seat, the retaining hole of the cover, the spring and the nut, and the outer threaded portion of the combination bolt is screwed on the nut, so that the combination bolt is combined with the nut, and the support seat is combined with the cover.
